(19) United States
(12) Patent Application Publication
(10) Pub. No.: US 2026/0092720 A1
(43) Pub. Date: Apr. 2, 2026

(54) CONNECTOR FOR HVAC DUCTING

(71) Applicant: Jeffrey A. Hermanson, Algona, WA (US)

(72) Inventor: Jeffrey A. Hermanson, Algona, WA (US)

(21) Appl. No.: 19/341,251

(22) Filed: Sep. 26, 2025

Related U.S. Application Data
(60) Provisional application No. 63/700,999, filed on Sep. 30, 2024.
(60) Provisional application No. 63/788,942, filed on Apr. 15, 2025.

(51) Int. Cl. F24F 13/02

(52) U.S. Cl. CPC F24F 13/0209

(57) ABSTRACT

A flanged ring connector to join adjacent ducts in an HVAC system includes a mating flange defining a mating face and an outer perimeter portion extending around the mating face. One section of the outer perimeter portion consists of a formed seam. An insertion flange extends laterally from the mating flange in the direction opposite to and away from the mating face. The insertion flange allows for fixed attachment to the adjacent end portion of an HVAC duct. A receiving channel extends along a second section of outer perimeter portion of the mating flange. The receiving channel projects from the mating face in a direction away from the direction that the insertion flange extends from the mating face. The receiving channel is shaped and sized to receive the formed seam of the mating flange of an adjacent flanged ring connector.

### CROSS-REFERENCES TO RELATED APPLICATIONS

This application claims the benefit of U.S. Provisional Application No. 63/788,942, filed Apr. 15, 2025, and the benefit of U.S. Provisional Application No. 63/700,999, filed Sep. 30, 2024, both of which applications are entirely incorporated herein by reference.

### BACKGROUND

The present disclosure relates to flanged ring connectors for connecting end-to-end single- or double-wall HVAC ducting of various cross-sectional shapes, such as square, rectangular, round, oval, elliptical, etc. Various types of connectors are utilized for this purpose. One type of connector is in the form of a flanged ring, which is connected to the end of a duct section to present a mating flange extending transversely to the length of the duct and extending radially or laterally from the exterior of the duct. The two mating flanges of the adjacent flanged rings may be attached together in face-to-face relationship by screws, bolts, or other hardware members extending through the mating flanges. Alternatively, connector rings or clips are used to entirely or partially encircle the exterior of the mating flanges of the adjacent flanged rings to fasten them together.

The present disclosure pertains to a flanged ring connector for HVAC ducting that eliminates or at least minimizes the use of hardware to connect HVAC ducting systems, while also removing the need to hold the connectors in alignment while the connectors are being bolted or otherwise fastened together.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a flanged ring connector is provided to join adjacent ducts in an HVAC system. The flanged ring connector includes a mating flange defining a mating face, the mating flange also defining a center and a polygonal outer perimeter portion extending around the mating face and the center of the mating flange, at least two adjacent sections of the outer perimeter portion comprising a formed seam comprising an edge section extending away from the mating face and a return section extending from the edge section toward the center, an insertion flange extending laterally from the mating flange in the direction opposite to and away from the mating face, the insertion flange having a length sufficient to allow fixed attachment with the adjacent end portion of an HVAC duct, a receiving channel extending along the other at least two adjacent sections of the outer perimeter portion of the mating flange, the receiving channel projecting from the mating face in a direction away from the direction that the insertion flange extends from the mating face, the receiving channel shaped and sized to receive the formed seam of the mating flange of an adjacent flanged ring connector.

In any of the embodiments described herein, wherein the mating face is planar.

In any of the embodiments described herein, wherein the mating face defines an opening in communication with the insertion flange.

In any of the embodiments described herein, wherein the mating face is selected from the shape selected from the group including square, rectangular, hexagonal, and octagonal.

In any of the embodiments described herein, wherein the insertion flange in cross-section is selected from the group selected from square, rectangular, hexagonal, octagonal, round, oval, and elliptical.

In any of the embodiments described herein, wherein the receiving channel is open in the direction toward the center of the mating flange.

In any of the embodiments described herein, wherein the receiving channel defining a base section projecting away from the mating face to transition into a distal side section that is disposed in spaced relationship with the mating face, the mating face, the base section, and the distal side section cooperating to form the receiving channel.

In any of the embodiments described herein, wherein the formed seam and the corresponding portion of the mating face are constructed from a singular sheet of metallic material.

In any of the embodiments described herein, wherein the receiving channel and the corresponding portion of the mating face are constructed from a single sheet of metallic material.

In any of the embodiments described herein, wherein the mating face, the formed seam, and the receiving channel are constructed as a single unit.

In any of the embodiments described herein, wherein the mating face, the formed seam, the receiving channel, and the insertion flange are constructed as a single unit.

In any of the embodiments described herein, wherein the flanged ring connector is formed at the end of an HVAC duct.

In accordance with another embodiment of the present disclosure, a flanged ring connector is provided to join end-to-end adjacent ducts in an HVAC system. The flanged ring connector includes a mating flange defining a mating face, the mating flange also defining a center and an outer perimeter portion extending around the mating face and the center of the mating flange, one half of the outer perimeter portion comprising a formed seam comprising an edge section extending away from the mating face and a return section extending from the edge section toward the center, an insertion flange extending laterally from the mating flange in the direction opposite to and away from the mating face, the insertion flange having a length sufficient to allow fixed attachment with the adjacent end portion of an HVAC duct, a receiving channel extending along one half of the outer perimeter portion of the mating flange not corresponding to the formed seam, the receiving channel projecting from the mating face in a direction away from the direction that the insertion flange extends from the mating face, the receiving channel shaped and sized to receive the formed seam of the mating flange of an adjacent flanged ring connector.

In any of the embodiments described herein, wherein the mating face is planar.

In any of the embodiments described herein, wherein the mating face defines an opening in communication with the insertion flange.

In any of the embodiments described herein, wherein the mating face is selected from the shape selected from the group including square, rectangular, hexagonal, and octagonal, circular, oval, and elliptical

In any of the embodiments described herein, wherein the insertion flange in cross-section is selected from the group selected from square, rectangular, hexagonal, octagonal, round, oval, and elliptical.

In any of the embodiments described herein, wherein the receiving channel is open in the direction toward the center of the mating flange.

In any of the embodiments described herein, wherein the receiving channel defining a base section projecting away from the mating face to transition into a distal side section that is disposed in spaced relationship with the mating face, the mating face, the base section, and the distal side section cooperating to form the receiving channel.

In any of the embodiments described herein, wherein the formed seam and the corresponding portion of the mating face are formed from a singular sheet of metallic material.

In any of the embodiments described herein, wherein the receiving channel and the corresponding portion of the mating face are formed from a single sheet of metallic material.

In any of the embodiments described herein, wherein the mating face, the formed seam, and the receiving channel are constructed as a single unit.

In any of the embodiments described herein, wherein the mating face, the formed seam, the receiving channel, and the insertion flange are constructed as a single unit.

In accordance with another embodiment of the present disclosure, a flanged ring connector is provided to join adjacent ducts in an HVAC system, the flanged ring connector. The connector includes a mating flange defining a mating face, the mating flange also defining a center and a polygonal outer perimeter portion extending around the mating face and the center of the mating flange, one section of the outer perimeter portion comprising a formed seam comprising an edge section extending away from the mating face and a first return section extending from the edge section toward the center, an insertion flange extending laterally from the mating flange in the direction opposite to and away from the mating face, the insertion flange having a length sufficient to allow fixed attachment with the adjacent end portion of an HVAC duct, a receiving channel extending along a second section of the outer perimeter portion of the mating flange, the receiving channel projecting from the mating face in a direction away from the direction that the insertion flange extends from the mating face, the receiving channel shaped and sized to receive the formed seam of the mating flange of an adjacent flanged ring connector.

In any of the embodiments described herein, wherein the mating face is planar.

In any of the embodiments described herein, wherein the mating face defines an opening in communication with the insertion flange.

In any of the embodiments described herein, wherein the mating face is selected from the shape selected from the group including square, rectangular, hexagonal, and octagonal.

In any of the embodiments described herein, wherein the insertion flange in cross-section is selected from the group selected from square, rectangular, hexagonal, octagonal, round, oval, and elliptical.

In any of the embodiments described herein, wherein the receiving channel is open in the direction toward the center of the mating flange.

In any of the embodiments described herein, wherein the receiving channel defining a base section projecting away from the mating face to transition into a distal side section that is disposed in spaced relationship with the mating face, the mating face, the base section, and the distal side section cooperating to form the receiving channel.

In any of the embodiments described herein, wherein the formed seam and the corresponding portion of the mating face are constructed from a singular sheet of metallic material.

In any of the embodiments described herein, wherein the receiving channel and the corresponding portion of the mating face are constructed from a single sheet of metallic material.

In any of the embodiments described herein, wherein the mating face, the formed seam, and the receiving channel are constructed as a single unit.

In any of the embodiments described herein, wherein the mating face, the formed seam, the receiving channel, and the insertion flange are constructed as a single unit.

In any of the embodiments described herein, wherein the formed seam and the receiving channel extending along opposite sections of the outer perimeter portion of the mating flange.

In any of the embodiments described herein, wherein the outer perimeter portion of the mating flange extending between the formed seam and the receiving channel comprising a hem section extending away from the mating face in the direction that the insertion flange extends from the mating face.

In any of the embodiments described herein, wherein the outer perimeter portion of the mating flange extending between the formed seam and the receiving channel further comprising a second return section extending from the hem section and toward the mating face in the direction opposite to the direction that the insertion flange extends from the mating face.

In any of the embodiments described herein, wherein the outer perimeter portion of the mating flange comprising a hem section extending between the formed seam and the receiving channel, the hem extending away from the mating face in the direction that the insertion flange extends from the mating face.

In any of the embodiments described herein, wherein the outer perimeter portion of the mating flange further comprising a second return section extending from the hem section and toward the mating face in the direction opposite to the direction that the insertion flange extends from the mating face.

In any of the embodiments described herein, wherein the wherein the mating face is square or rectangular, and the formed seam extends along the top or bottom of the mating face and the receiving channel extends along the opposite of the location of the formed seam.

In any of the embodiments described herein, wherein the wherein the mating face is square or rectangular, and the formed seam extends along one side of the mating face and the receiving channel extends along one side of the mating flange opposite to the location of the formed seam.

In accordance with another embodiment of the present disclosure, a flanged ring connector to join end-to-end adjacent ducts in an HVAC system is provided. The flanged ring connector includes: a mating flange defining a mating face, the mating flange also defining a center and an outer perimeter portion extending around the mating face and the center of the mating flange, a first portion of the outer perimeter portion comprising a formed seam comprising an edge section extending away from the mating face and a return section extending from the edge section toward the center; an insertion flange extending laterally from the mating flange in the direction opposite to and away from the mating face, the insertion flange having a length sufficient to allow fixed attachment with the adjacent end portion of an HVAC duct; a receiving channel extending along a second portion of the outer perimeter portion of the mating flange not corresponding to the formed seam, the receiving channel projecting from the mating face in a direction away from the direction that the insertion flange extends from the mating face, the receiving channel shaped and sized to receive the formed seam of the mating flange of an adjacent flanged ring connector.

In any of the embodiments described herein, wherein approximately half of the outer perimeter portion comprising a formed seam and the receiving channel extending along a second portion of the outer perimeter portion of the mating flange not corresponding to the formed seam.

In accordance with another embodiment of the present disclosure, a flanged connector used to join double wall ducts in HVAC systems, the double wall ducts having an outer duct and an inner duct of corresponding shape and disposed within the outer duct, is provided. The flanged connector includes: a first connector section composed of an outer insertion flange, the outer insertion flange having sufficient length to allow connection to an outer duct of a double wall duct; an exterior mating flange extending substantially transversely from the outer insertion flange to define a first mating face and a first outer perimeter; a second connector section composed of an inner insertion flange, said inner insertion flange having sufficient length to allow connection to an inner duct of a double wall duct; an inner mating flange extending substantially transversely from the inner insertion flange to define a second mating face; an inner hem that is substantially uniformly spaced outwardly from the inner insertion flange, said inner hem extending from the outer perimeter of the interior mating flange generally in the same direction as the inner insertion flange to overlap the outer insertion flange, wherein the inner hem is connected to the outer insertion flange such that the inner mating flange and the outer mating flange are aligned to form substantially one plane, the inner hem being of such length to permit the outer insertion flange to be connected to the outer duct and having sufficient length to allow connection with the outer insertion flange; at least one section of the first outer perimeter comprising a formed seam comprising an edge section extending away from the first mating face and a first return section extending from the edge section toward the first insertion flange; a receiving channel extending along at least a second section of the first outer perimeter portion of the exterior mating flange, the receiving channel projecting from the first mating face in a direction away from the direction that the first insertion flange extends from the first mating face, the receiving channel shaped and sized to receive the formed seam of the exterior mating flange an adjacent flanged ring connector.

In any of the embodiments described herein, wherein the formed seam and the receiving channel extending along opposite sections of the first outer perimeter portion of the exterior mating flange.

In any of the embodiments described herein, wherein the formed seam extending along at least two adjacent sections of the outer perimeter portion of the exterior mating flange, and the receiving channel extending along the other at least two adjacent sections of the outer perimeter portion of the exterior mating flange.

In any of the embodiments described herein, wherein the outer perimeter portion of the exterior mating flange extending between the formed seam and the receiving channel comprising a hem section extending away from the first mating face in the direction that the insertion flange extends from the first mating face or opposite to the direction that the first insertion flange extends from the first mating face.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a top or plan view of a flanged ring connector of the present disclosure;

FIG. 2 is a side perspective view of the flanged ring connector of FIG. 1 taken from the opposite side of the connector;

FIG. 3 is an enlarged partial view showing two flanged ring connectors assembled together in locked relationship;

FIG. 4 is a perspective view of two flanged ring connectors in partially locked relationship;

FIG. 5 is a perspective view of two flanged ring connectors in locked relationship taken from the opposite side of FIG. 4;

FIG. 6 is a partial pictorial view showing two flanged ring connectors in face-to-face relationship and partially locked together;

FIG. 7 is a pictorial view of two flanged ring connectors spaced apart from each other and illustrating their orientations for being locked together;

FIG. 8 is a side perspective view of a flanged ring connector view of a further embodiment of flanged ring connector of the present disclosure;

FIG. 9 is a side perspective view of the flanged ring connector of FIG. 8 taken from the opposite side of the connector;

FIG. 10 is an enlarged partial view showing the two flanged ring connectors of FIG. 8 assembled together in locked relationship;

FIG. 11 is a partial pictorial view showing the two flanged ring connectors of FIG. 8 in face-to-face relationship and partially locked together;

FIG. 12 is a pictorial view of the two flanged ring connectors of FIG. 8 spaced apart from each other and illustrating their orientations for being locked together;

FIG. 13-FIG. 15 are fragmentary cross-sectional views of embodiments of portions of flanged ring connectors in face-to-face relationship.

FIG. 16 is a side perspective view of a flanged ring connector view of a further embodiment of flanged ring connector of the present disclosure for interconnecting double walled ducting;

FIG. 17A is an enlarged cross-sectional view of a further embodiment of the present disclosure wherein the formed seam is shown as being shaped as a portion of a circle;

FIG. 17B is an enlarged cross-sectional view of a further embodiment of the present disclosure wherein the receiving channel for receiving the form seam shown in FIG. 17A is shown as being of complementary shape also the shape of a portion of a circle.

### DETAILED DESCRIPTION

Various example embodiments of the present disclosure are described below with reference to the accompanying drawings in which some example embodiments are illustrated. In the figures, the thicknesses of lines, layers, and/or regions may be exaggerated for clarity.

While example embodiments are capable of various modifications and alternative forms, embodiments thereof are shown by way of example in the figures and are described in detail below. It should be understood, however, that there is no intent to limit example embodiments to the particular forms disclosed, but on the contrary, example embodiments are to cover all modifications, equivalents, and alternatives falling within the scope of the disclosure.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be considered in the specific context this definition is given herein.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

The present application may include references to directions, such as “forward,” “rearward,” “front,” “back,” “ahead,” “behind,” “upward,” “downward,” “above,” “below,” “top,” “bottom,” “right hand,” left hand,” “in,” “out,” “extended,” “advanced,” “retracted,” “proximal,” “distal,” “central,” “vertical,” etc. These references and other similar references in the present application are only to assist in helping describe and understand the present invention and are not intended to limit the present invention to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out. If a quantitative value is needed to render the applicable parameter sufficiently definite, the applicable parameter is within five percent (5%) of the designated parameter value.

In the following description, various embodiments of the present disclosure are described. In the following description and in the accompanying drawings, the corresponding systems assemblies, apparatus, and units may be identified by the same part number, but with an alpha suffix or by a prime (“′”) or double prime (“″”) or even a triple prime (“″′”) designation. Or the corresponding systems assemblies, apparatus, and units may be identified by the corresponding part numbers of a different series, such as a 200 series or 300 series. The descriptions of the parts/components of such systems assemblies, apparatus, and units that are the same or similar are not repeated so as to avoid redundancy in the present application.

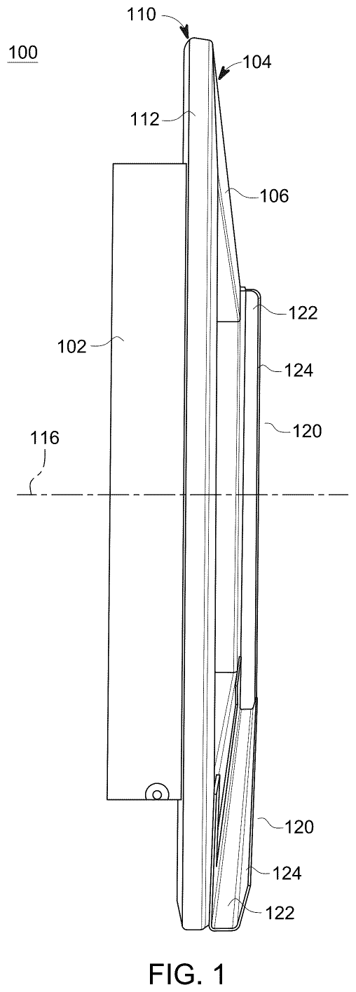

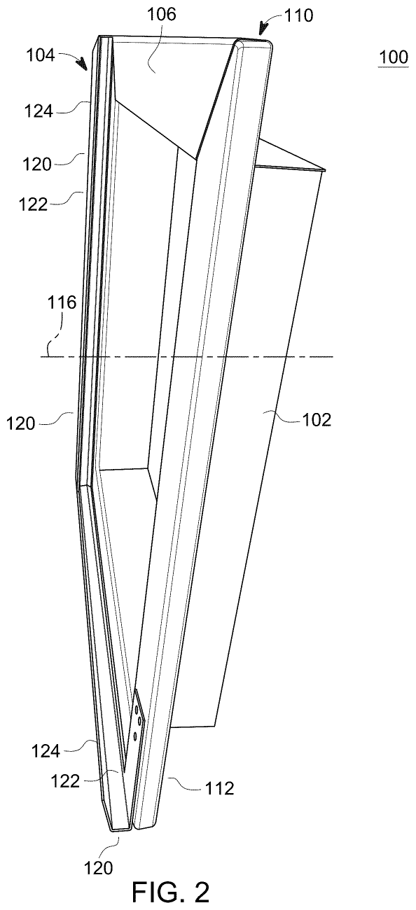

Referring initially to FIGS. 1, 2, and 7, in one embodiment of the present disclosure, a flanged connector ring 100 for connecting adjacent ends of HVAC ducting includes an insertion flange portion 102 to closely engage within the interior (or exterior) of the end of a HVAC duct. As such the insertion flange is of the same shape as the cross-sectional shape of the HVAC duct. The insertion flange portion 102 is sized to closely slide into (or over) the end of the HVAC duct. The HVAC ducting can be of various shapes, such as square, rectangular, hexagonal, octagonal, round or circular, oval, elliptical. As such, the insertion flange portion 102 will be of the same shape. Also, the HVAC ducting can be of various sizes. For example, the ducting can be as small as about a foot in diameter or width and up to at least several feet in diameter or width.

The flanged connector ring also includes a mating flange portion 104 that extends transversely or laterally outwardly from the insertion flange portion 102 to encircle the insertion flange portion 102. The mating flange portion 104 provides a planar mating face 106 to present to the mating face to corresponding mating flange portion of the flanged ring connector attached to the end of the adjacent HVAC duct to be connected.

Although in FIGS. 1, 2, and 7 the mating flange portion 104 is shown as being of a shape corresponding to the cross-sectional shape of the insertion flange portion 102, this does need to be the case. For example, the mating flange portion 104 may be square or rectangular in shape while the insertion flange portion may be round, oval, elliptical, etc. in cross-section. Or, as another example, the mating flange portion may be round in shape and the insertion flange portion may be square or rectangular in cross-section shape.

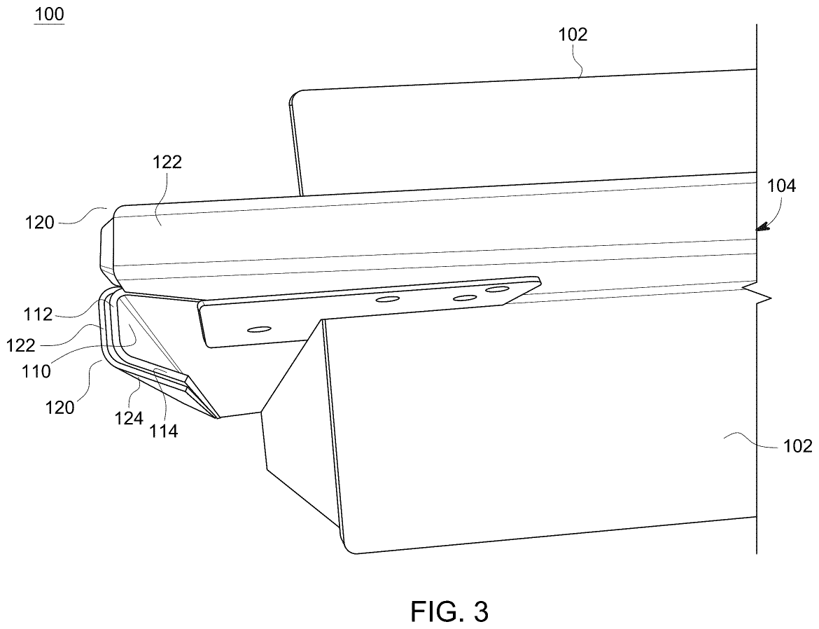

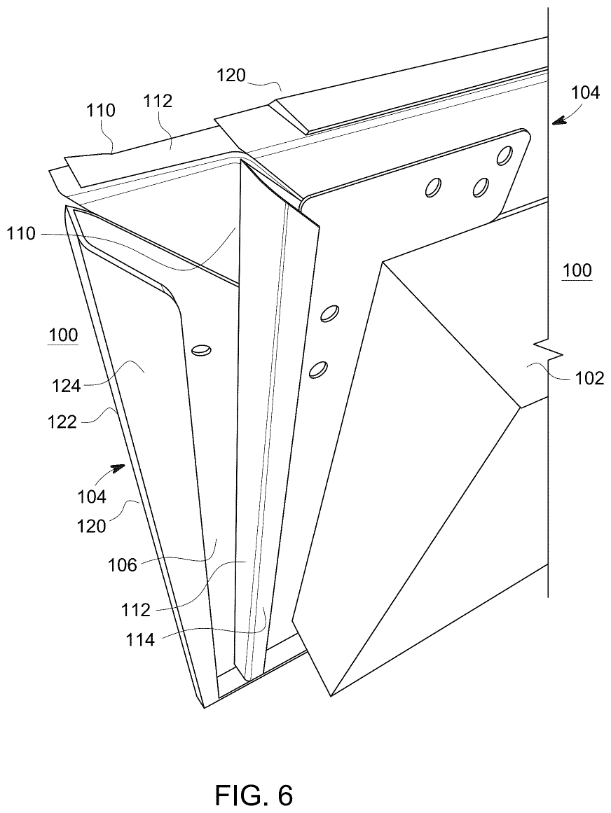

Also referring FIGS. 3 and 6, the mating flange portion 104 includes a formed seam 110 extending along two adjacent sides of the outer perimeter of the mating face 106 of the mating flange portion. As discussed below, the formed seam 110 forms part of the connector system for interconnecting adjacent flanged connectors 100. The formed seam also adds strength and rigidity to the mating flange portion 104 to assist in the mating face 106 remaining planar.

In one embodiment of the present disclosure, the formed seam 110 is composed of an edge section 112 that extends transversely to the mating face 106 in the direction that the insertion flange portion extend from the mating face, thereby forming the outer edge portion of the mating flange portion. The edge section 112 intersects and transitions into a return section 114 that extends laterally from the edge section towards the center 116 of the flanged connector. The return section also is shown as flaring or extending away from the back side of the mating face 106, see for example, FIG. 3.

As shown in in FIGS. 1, 2, 3, 6, and 7, a formed receiving channel 120 extends along the other two adjacent sides of the outer perimeter of the mating face 106 of the mating flange portion 104 from the location of the formed seam 110. As discussed below, the formed seam receiving channel 120 forms the saddle part of the connector system for connecting adjacent flanged connectors 100. The formed receiving channel or saddle 120 also adds strength and rigidity to the mating flange portion 104 to assist in the mating face 106 remaining planar.

The receiving channel 120 includes a base section 122 projecting or extending away from the mating face 106 to transition into a distal side section 124 that extends across the mating face 106 in spaced relationship with the mating face. In this manner, the mating face 106, the base section 122, and the distal side section 124 cooperate to form the receiving channel 120.

Also, the distal side section 124 flares away from the mating face in the same manner that the return section 114 of the formed seam 110 also flares or extends away from the back side of the mating face 106. In this manner, the shape of the receiving channel closely corresponds to the shape of the formed seam. Further, as discussed below, the receiving channel 120 closely receives the formed seam 110 of an adjacent flanged connector.

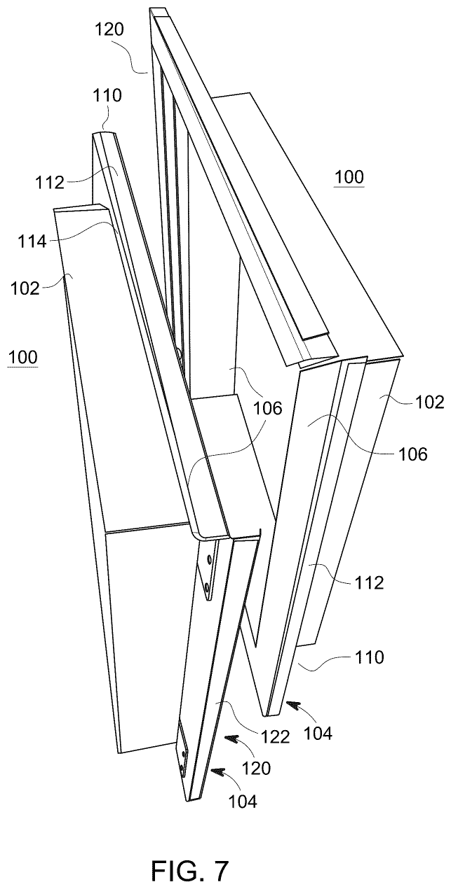

As shown in FIGS. 6 and 7, with the above construction of the flanged connector 100, two flanged connectors 100 can be conveniently assembled and locked together so the mating faces 106 of the flanged connectors are in face-to-face sealed contact with each other. In this regard, the two flanged connectors can be placed face-to-face with each other wherein the receiving channel 120 at the top of one flanged connector 100 is engaged (although perhaps not fully engaged) over the formed seam 110 of the other flanged connector 100, as shown in FIG. 6. Then, the two flanged connectors can be slid relative to each to other to wedge the formed seams 110 of the flanged connectors into corresponding receiving channels 120 of the flanged connectors. This saddle relationship between the receiving channels 120 and the formed seams 110 securely locks the two flanged connectors to each other.

It can be appreciated that there is no need to hold the two flanged connectors together in alignment while screws and bolts are installed to fasten the flanged connectors together or while a band or clip is positioned over the flanged connectors to fasten them together. In a typical installation, the HVAC ducts are installed at the ceiling of a structure often high above the floor level, making it quite an advantage if the HVAC ducts can be connected together quickly and easily and with a minimum of assembly.

However, if desired, or deemed necessary, a single screw or clip can be used to insure that the two flanged connectors 100 remain in face-to-face relationship to each other. In this regard, a sheet metal screw can be extended though the receiving channel 120 and corresponding formed seam 110 along any of the sides of the flanged connector 100. As an alternative, a different type of hardware member of clip can be used for this purpose.

The flanged connectors 100 can be manufactured in numerous ways. For example, each flanged connector can be manufactured from two formed sections that are assembled together to form the complete unit. In this regard, one section is composed of the section of the flanged connector that includes the formed seam 110, and the second section is composed of the section of the flanged connector that includes the receiving channel 120.

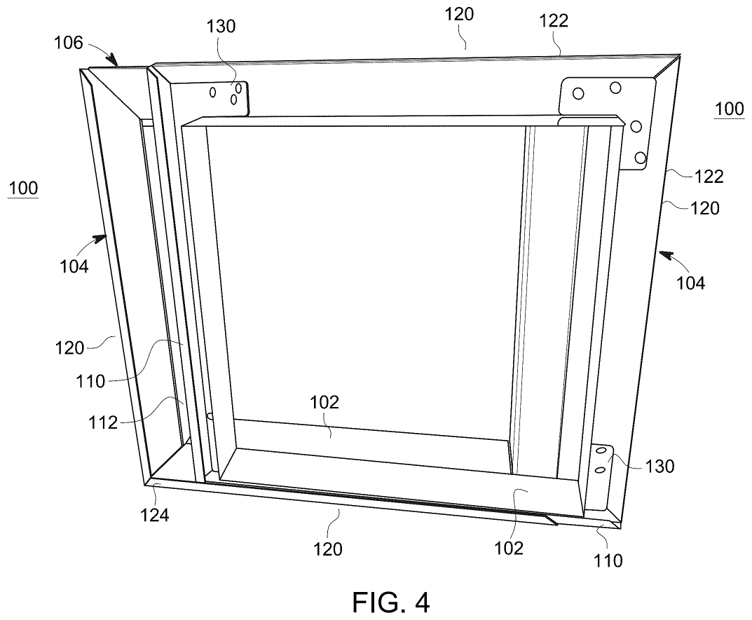

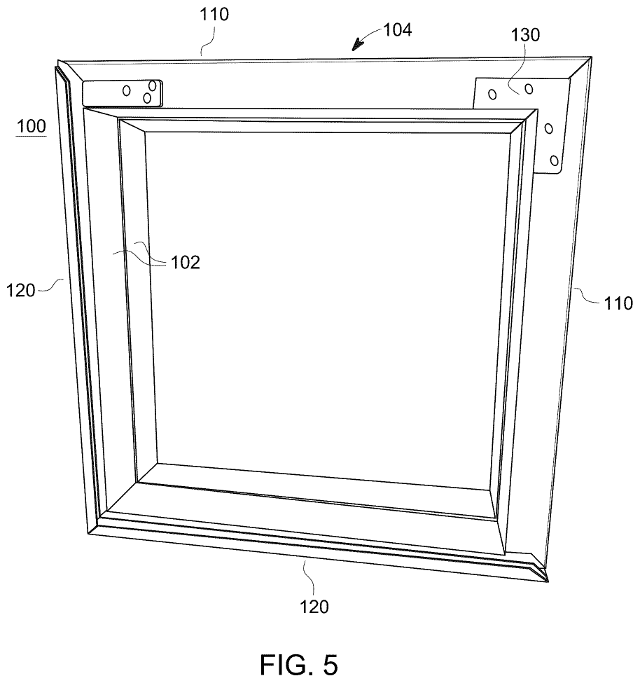

Each of the two sections can be manufactured from strip stock that has been precut into a required shape and then formed using roll forming tools or bending tools or a combination of roll forming tools and bending tools and other tools. Such roll forming and bending processes are known to one skilled in the art. In this regard, see, for example, U.S. Pat. Nos. 9,101,969 and 11,953,225. Once formed, the two sections can be assembled together to achieve a complete connector. In this regard, the two sections can be tack welded and/or spot welded at their junctures as shown in the figures. Also, flat angle braces 130 can be welded to the back sides of the mating faces 106 at the junctures of the two sections, for examples as shown in FIGS. 4, 5, and 6. Of course, other fastening methods and techniques can be used.

As an alternative, the flanged connectors 100 can be compose of four formed sections, that are assembled together to form a complete unit. In this regard, each side of the flanged connector 100 can be composed of a formed unit. Each of the four sections can be manufactured from strip stock that has been precut into a required shape and then formed using roll forming tools or bending tools or a combination of roll forming tools and bending tools or other tools. As noted above, such roll forming and bending tools and processes are known to one skilled in the art.

Once formed the four sections can be assembled together to form a complete connector. In this regard, the four sections can be tack welded and/or spot welded at their junctures as shown in the figures. Also, flat angle braces 130 can be welded to the back sides of the mating faces 106 at the junctures of the four sections, for examples as shown in FIGS. 4, 5, and 6.

While illustrative embodiments have been illustrated and described, it will be appreciated that various changes can be made therein without departing from the spirit and scope of the invention. For example, rather than being of a generally box shape as shown in FIGS. 3 and 6, the formed seam 110 and the receiving channel or saddle can be of other cross-sectional shapes, such as in the form of a half-round or a Vee.

In addition, a seal or gasket can be used to help ensure that an air leak does not occur at the juncture of two flanged connectors. The seal or gasket can be composed of, for example, a compressible material such as natural or synthetic rubber or a sealing calk. The seal or gasket can be pre-applied to the interior of the receiving channels or to one of the mating faces 106 or elsewhere on the flanged connector(s) 100.

Further, the flanged connectors of the present disclosure can be of other rectilinear or polygonal shapes other than the square shape shown in the figures. For example, the flanged connectors of the present disclosure can be formed in a rectangular shape. Additional shapes include hexagonal, octagonal, etc. In these other shapes, a formed seam extends along one half of the perimeter of the mating face, and a receiving channel extends along the other half of the perimeter of the mating face. This allows two flanged connectors to be joined and locked together with the receiving channel of one flanged connector saddled over the formed seam of the other flanged connector.

In addition, the flanged connectors of the present disclosure can be of a non-polygonal shape, for example, round or circular, oval, elliptical, etc. In these additional shapes, a formed seam extends along one half of the perimeter of the mating face, and a receiving channel extends along the other half of the perimeter of the mating face. This allows the two flanged connectors to be joined by sliding relative to each other, and then locked together with the receiving channel of one flanged connector saddled over the formed seam of the other flanged connector.

In addition or in lieu of the roll forming and bending tools noted above, the non-polygonal shaped flanged connectors can be fully or partially formed using spin forming tools, examples of which are disclosed in the patents noted above.

Also, the flanged connectors of the present disclosure can be manufactured by 3D printing, including if the flanged connectors are composed of a polymer material. The use of 3D printing can enable the entire flanged connector to be constructed as a singular unit or structure. 3D printing systems to manufacture the flanged connectors of the present disclosure are articles of commerce.

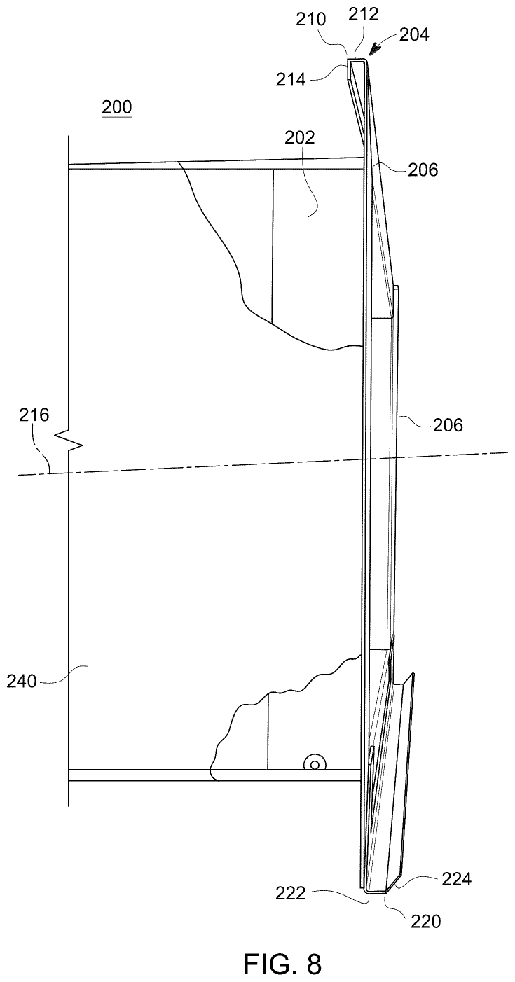

Referring to FIGS. 8-13, another embodiment of a flanged connector ring 200 of the present disclosure for connecting adjacent ends of HVAC ducting 240 is shown. This flanged ring connector and its components are designated with corresponding 200 series item numbers. In this regard, the flanged ring connector 200 includes an insertion flange portion 202 to closely engage within the interior (or exterior) of the end of a HVAC duct 240. As such, the insertion flange is of the same shape as the cross-sectional shape of the HVAC duct 240. The insertion flange portion 202 is sized to closely slide into (or over) the end of the HVAC duct 240. The HVAC ducting 240 can be of various shapes, such as square, rectangular, hexagonal, octagonal, round or circular, oval, elliptical. As such, the insertion flange portion 202 will be of the same shape. Also, the HVAC ducting 240 can be of various sizes. For example, the ducting can be as small as about a foot in diameter or width and up to at least several feet in diameter or width.

The flanged connector ring also includes a mating flange portion 204 that extends transversely or laterally outwardly from the insertion flange portion 202 to encircle the insertion flange portion 202. The mating flange portion 204 provides a planar mating face 206 to present to the mating face to a corresponding mating flange portion of the flanged ring connector attached to the end of an adjacent HVAC duct 240 to be connected.

Although in FIGS. 8, 9, and 12 the mating flange portion 204 is shown as being of a shape corresponding to the cross-sectional shape of the insertion flange portion 202, this does need to be the case. For example, the mating flange portion 204 may be square or rectangular in shape while the insertion flange portion may be round, oval, elliptical, etc. in cross-section. Or, as another example, the mating flange portion 204 may be round in shape and the insertion flange portion may be square or rectangular in cross-section shape.

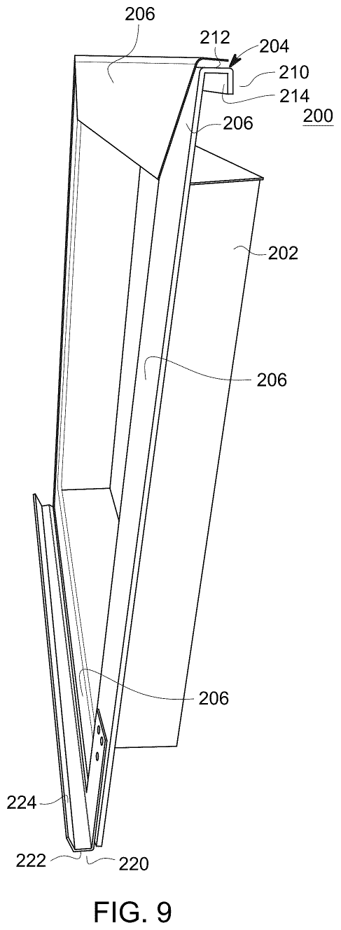

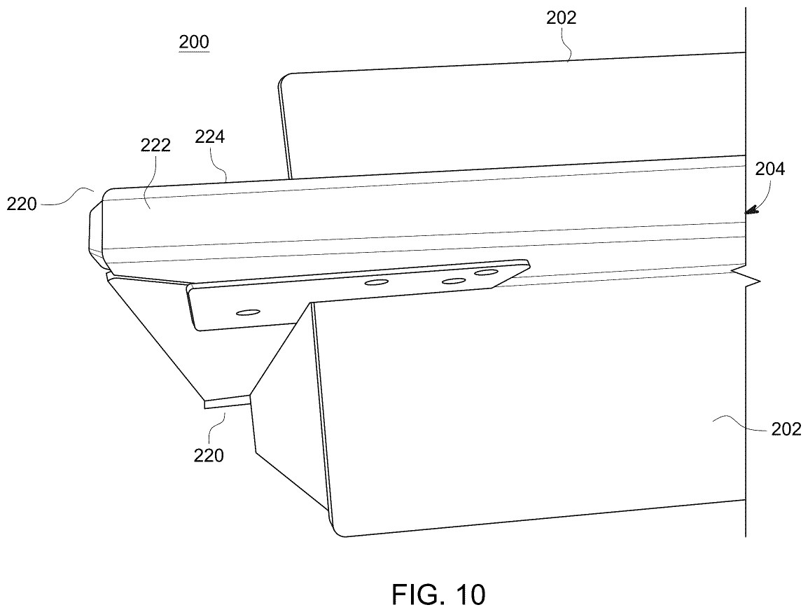

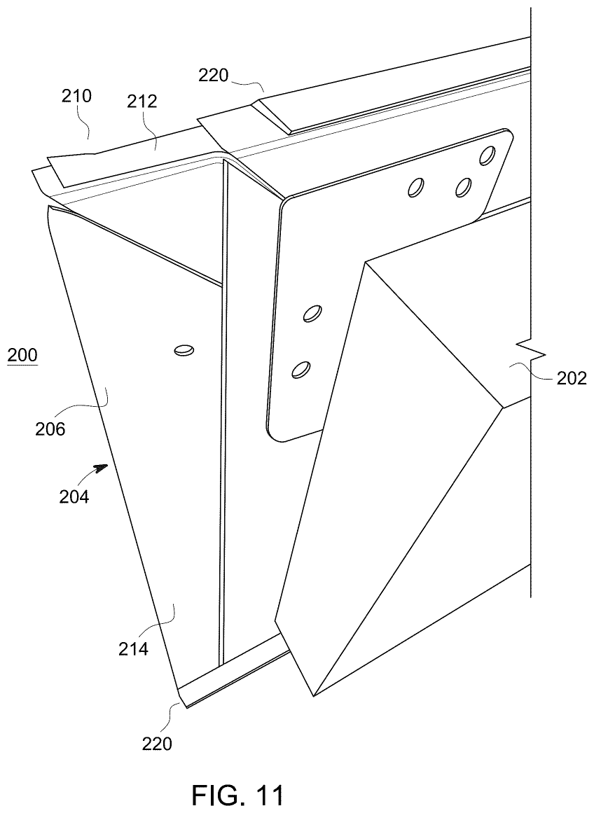

Additionally referring FIGS. 10 and 11, the mating flange portion 204 includes a formed seam 210 extending along the first side of the outer perimeter of the mating face 206 of the mating flange portion. As non-limiting examples, in FIGS. 8 and 9 the formed seam 210 extends along the outer perimeter of the top section of the mating face 206, and correspondingly in FIGS. 11, the formed seam 210 extends along the outer perimeter of the bottom section of the mating face 206. The formed seams 210 need not be in these locations, rather they can be located along the side sections of the mating flange face 206.

As discussed below, the formed seams 210 form part of the connector system for interconnecting adjacent flanged connectors 200. The formed seams also add strength and rigidity to the mating flange portions 204 to assist in the mating faces 206 remaining planar.

In an example of the present disclosure, the formed seam 210 is composed of an edge section 212 that extends transversely to the mating face 206 in the direction that the insertion flange portion 202 extends from the mating face 206, thereby forming an outer edge portion of the mating flange portion 204. The edge section 212 intersects and transitions into a first return section 214 that extends laterally from the edge section 212 towards the center 216 of the flanged connector 200. The return section 214 can be configured to flare or extend away from the back side of the mating face 206, in the same manner as shown in FIG. 3.

As shown in in FIGS. 8, 9, and 12, a formed receiving channel 220 extends along a side of the outer perimeter of the mating face 206 of the mating flange portion 204 opposite to the location of the formed seam 210. In this regard, in the flanged connector 200 shown in FIGS. 8 and 9 the formed receiving channel 220 extends along the bottom section of the mating face 206.

As discussed below, the formed seam receiving channels 220 form the saddle part of the connector system for connecting adjacent flanged connectors 200. The formed receiving channel or saddle 220 also adds strength and rigidity to the mating flange portions 204 to assist in the mating faces 206 remaining planar.

The receiving channel 220 includes a base section 222 projecting or extending away from the mating face 206 to transition into a distal side section 224 that extends across the mating face 206 in spaced relationship with the mating face. In this manner, the mating face 206, the base section 222, and the distal side section 224 cooperate to form the receiving channel 220 for receiving the formed seam 210 of the flanged connector 200 of the adjacent duct section.

Also, the distal side section 224 can be formed to flare away from the mating face 206 in the same manner that the return section 214 of the formed seam 210 can be formed to flare or extend away from the back side of the mating face 206. In this manner, the shape of the receiving channel 220 closely corresponds to the shape of the mating formed seam 210. Further, as discussed below, the receiving channel 220 closely receives the formed seam 210 of an adjacent flanged connector 200.

As shown in FIGS. 8-13, the sections of the mating flange portion 204 extending between the formed seam 210 and the receiving channel 220 can consist of the just the mating face sections. In the non-limiting example of FIGS. 8-13, these sections of the mating flange portion 204 are the vertical sections of the mating flange portion. Of course, if the formed seam 210 and receiving channel 220 are located along other sections of the mating flange portion 204, then the locations of the plain mating face sections extending between the formed seam 210 and the receiving channel 220 would be repositioned accordingly.

The planar mating face sections 206 of adjacent flanged connectors 200 can be secured together in face-to-face relationship by numerous standard techniques. For example, screws, bolts, clips or other hardware members can be used for this purpose.

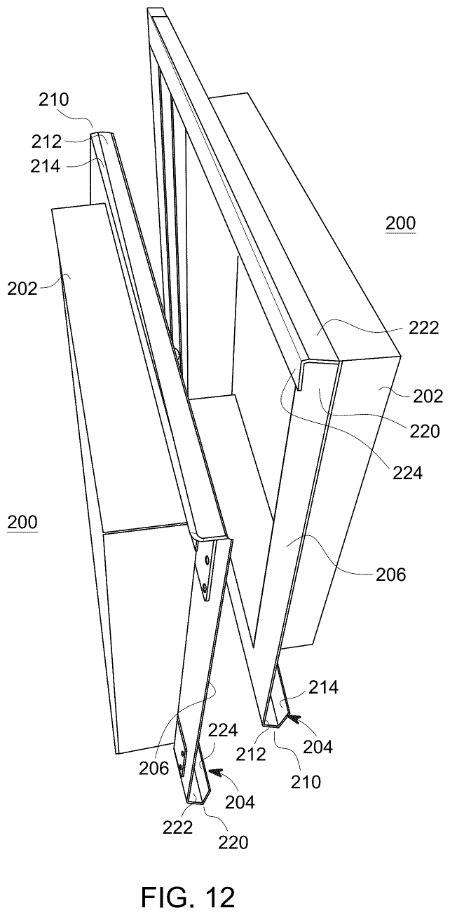

As shown in FIGS. 11 and 12, with the above construction of the flanged connectors 200, two flanged connectors 200 can be conveniently assembled and locked together so the mating faces 206 of the flanged connectors are in face-to-face sealed contact with each other. In this regard, the two flanged connectors 200 can be placed face-to-face with each other wherein the receiving channel 220 at the top of one flanged connector 200 is engaged over the formed seam 210 at the top of the other flanged connector 200. Then, the two flanged connectors can be slid vertically relative to each to other to wedge the formed seams 210 of the flanged connectors into corresponding receiving channels 220 of the flanged connectors along the tops of the flanged connectors 200 as well as at the bottoms of the flanged connectors 200. This saddle relationship between the receiving channels 220 and the formed seams 210 securely locks the two flanged connectors 200 to each other.

It will be appreciated that the two flanged connectors 200 shown in FIGS. 11 and 12 can be identical, with one of the flanged connectors 200 rotated 180 degrees relative to the other flanged connector 200.

It also will be appreciated that by engaging the formed seams 210 in to corresponding receiving channels 220, the flanged connectors 200 are held or locked together, so there is no need for installers to physically hold the ends of adjacent HVAC duct sections together while the screws, bolts, clips or other hardware members are being installed.

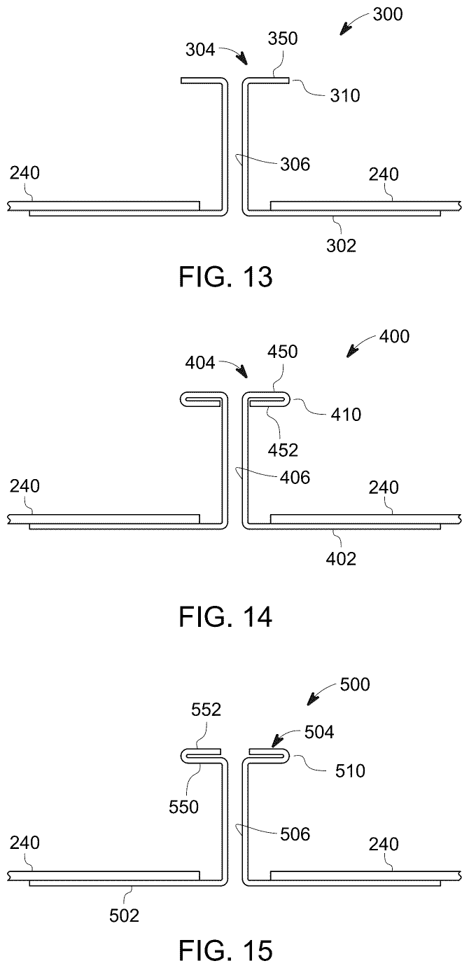

FIGS. 13, 14, and 15 illustrate further embodiments of the flanged ring connectors of the present disclosure where the connectors are designated by 300, 400, and 500 series numbers, respectively. FIGS. 13, 14, and 15 show different embodiments of the mating face sections 306, 406, and 506 of the mating flange portions 304, 404, and 504. The depicted mating flange portions 304, 404, and 504 extending between corresponding formed seams and receiving channels such as shown in FIGS. 8-12.

In the flanged ring connector 300 of FIG. 13, a hem section 350 that extends laterally from the outer perimeter of the mating face 306 to extend in the direction that insertion flange 302 extends from the mating face. The hem section 350 adds rigidity to the mating face 306.

FIG. 14 shows a flanged ring connector 400 wherein a hem section 450 extends laterally from the outer perimeter of the mating face 406 to extend in the direction that insertion flange 402 extends from the mating face 406. In addition second return section 452 underlies the hem section 450 thereby to add further mass and rigidity to the flanged ring connector.

FIG. 15 shows a flanged ring connector 500 wherein a hem section 550 extends laterally from the outer perimeter of the mating face 506 to extend in the direction that insertion flange 502 extends from the mating face 406. In addition, second return section 552 overlies the hem section 550 thereby to increase the mass and rigidity to the flanged ring connector.

It is to be understood that numerous other configurations of hem sections and return sections can be employed to increase the rigidity of the flanged ring connectors 200-500 and in particular the mating flange portions 204, 304, 404, and 504. In this regard, the disclosure of U.S. Pat. No. 7,743,504 is incorporated by reference its entirety into the present application.

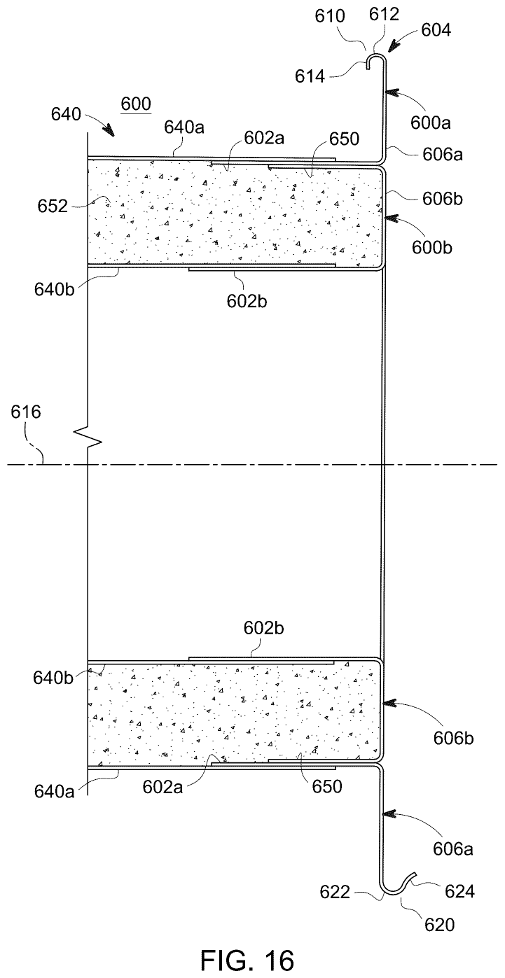

Referring to FIG. 16, another embodiment of a flanged connector ring 600 of the present disclosure for connecting adjacent ends of double wall HVAC ducting 640 is shown. This flanged ring connector and its components are designated with corresponding 600 series item numbers.

In this regard, the flanged ring connector 600 includes a first larger flanged ring portion 600A and a second smaller flanged ring portion 600B fastened together to form a single double wall flanged connector 600. The flanged connectors 600A and 600B are then attached to a double wall duct 640.

The flanged connector 600 is created by joining the first outer or larger flanged portion 600A to the second inner or smaller flanged portion 600B. The first flanged connector portion 300A may consist of an outer insertion flange section 602A that is of sufficient length to connect to the outer wall 640A of the double wall duct 640. An outer mating flange 606A extends transversely from the outer insertion flange section 602A to intersect with the formed seam 610 along the top of the first flanged connector portion 600A and with the receiving channel 622 at the bottom of the first flanged connector portion 600A.

At the sides, the outer mating flange 606A may intersect with an outer hem, corresponding to hems 350, 450 or 550 as shown in FIGS. 13, 14 and 15. Of course, the outer hem can be of other configurations as disclosed in U.S. Pat. No. 7,743,504

The second flanged connector portion 600B may consist of an inner insertion flange section 602B that is of sufficient length to connect to the inner wall 640B of the double wall duct 640. An inner mating flange 606B extends transversely outward from the inner insertion flange 602B and is in alignment with the outer mating flange 606A, to intersect with an inner hem 650 that extends along the outer insertion flange section 602A along the inside surface thereof. The inner hem 650 extends far enough along the outer insertion flange section 602A to allow for connection thereto but not so far as to interfere with the connection of the outer insertion flange section 602A with the outer wall 640A of the double wall duct 640

The first and second flanged connector portions 600A and 600B may be connected to form a singular rigid construction by any convenient means, such by welding.

The annular space between the outer wall 640A and the inner wall 640B of the duct 640 can be filled with an insulating material 652. Such material may include, for example, an expanded foam or rock wool or fiber glass, etc.

The separation between the outer wall 640A and the inner wall 640B of the duct 640 may be of various dimensions depending on the desired level or insulating material, as well as the size of the duct. Such separation may be a little as 1 inch or as large as 6 inches. This in turn dictates the separation between the outer insertion flange 602A and 602B.

Further, the flanged connector 600 can be attached to the end of double wall duct 640 by any convenient means, such as by use of screws or other hardware members. Another attachment means may include welding.

As a further alternative, the flanged connectors 100, 200, and/or 600 may be integrally formed at the ends of corresponding duct with use of numerous techniques, including roll forming, spin forming, etc. In this regard, the disclosure of U.S. Pat. Nos. 7,163,030, 7,743,504 and 11,953,225 are incorporated in their entirety herein.

In addition, the cross-section shapes of the outer and inner flanged connector portions can be of other constructions, such as shown in U.S. Pat. No. 7,163,030 and 11,953,225.

The insertion flange portions 602A and 602B closely engage within the interior (or exterior) ends of the HVAC duct 640. As such, the insertion flanges are of the same shape as the cross-sectional shape of the HVAC duct 640. The insertion flange portions 602A and 602B are sized to closely slide into (or over) the ends of outer and inner walls 640A and 640B of the HVAC duct 640. The HVAC ducting 640 can be of various shapes, such as square, rectangular, hexagonal, octagonal, round or circular, oval, elliptical. As such, the insertion flange portions 602A and 602B will be of the same shape.

Also, the HVAC ducting 640 can be of various sizes. For example, the ducting can be as small as about a foot in diameter or width and up to at least 10 or 12 feet in diameter or width.

The flanged connector 600 also includes a mating flange portions 606A and 606B that extend transversely or laterally outwardly from their insertion flange portion 602A and 602B to encircle the insertion flange portions. The mating flange portions 606A and 606B cooperatively provide a planar mating face to present to the mating face to a corresponding mating flange portion of the flanged ring connector attached to the end of an adjacent HVAC duct 640 to be connected.

Although in FIG. 16 the mating flange portions 606A and 606B are shown as being of a shape corresponding to the cross-sectional shape of the insertion flange portions 602A and 602B, this does need to be the case. For example, the mating flange portions 606A and 606B may be square or rectangular in shape while the insertion flange portions may be round, oval, elliptical, etc. in cross-section. Or, as another example, the mating flange portions 606A and 606B may be round in shape and the insertion flange portions may be square or rectangular in cross-section shape.

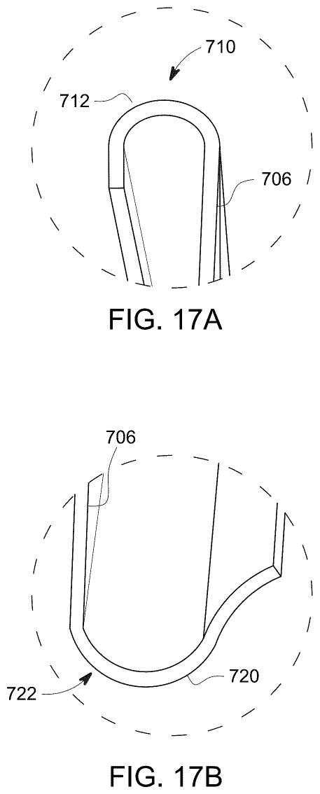

FIGS. 17A and 17B illustrate that the formed seam 710 and the corresponding receiving channel 722 in cross-sectional shape may define a portion of a circle, rather than being of the generally square/rectangular shape shown in FIGS. 1-12.

As further alternatives, the formed seam and corresponding receiving channel may be other shapes, such as a Vee shape or other angular shape such that the formed seam and the receiving channel closely fit together.

While illustrative embodiments have been illustrated and described, it will be appreciated that various changes can be made therein without departing from the spirit and scope of the invention.

1. A flanged ring connector to join adjacent ducts in an HVAC system, the flanged ring connector comprising:
a mating flange defining a mating face, the mating flange also defining a center and a polygonal outer perimeter portion extending around the mating face, at least one section of the outer perimeter portion comprising a formed seam comprising an edge section extending away from the mating face and a first return section extending from the edge section toward the center;
an insertion flange extending laterally from the mating flange in the direction opposite to and away from the mating face, the insertion flange having a length sufficient to allow attachment with the adjacent end portion of an HVAC duct; and
a receiving channel extending along at least a second section of the outer perimeter portion of the mating flange, the receiving channel projecting from the mating face in a direction away from the direction that the insertion flange extends from the mating face, the receiving channel shaped and sized to receive the formed seam of the mating flange of an adjacent flanged ring connector.

2. The flanged ring connector of claim 1, wherein the mating face is planar.

3. The flanged ring connector of claim 1, wherein the mating face defines an opening in communication with the insertion flange.

4. The flanged ring connector of claim 1, wherein the mating face is selected from the shape selected from the group including square, rectangular, hexagonal, and octagonal.

5. The flanged ring connector of claim 1, wherein the insertion flange in cross-section is selected from the group selected from square, rectangular, hexagonal, octagonal, round, oval, and elliptical.

6. The flanged ring connector of claim 1, wherein the receiving channel is open in the direction toward the center of the mating flange.

7. The flanged ring connector of claim 6, wherein the receiving channel defining a base section projecting away from the mating face to transition into a distal side section that is disposed in spaced relationship with the mating face, the mating face, the base section, and the distal side section cooperating to form the receiving channel.

8. The flanged ring connector of claim 1, selected from the group consisting of wherein: the formed seam and the corresponding portion of the mating face are constructed from a singular sheet of metallic material; the receiving channel and the corresponding portion of the mating face are constructed from a single sheet of metallic material; the mating face, the formed seam, and the receiving channel are constructed as a single unit; the mating face, the formed seam, the receiving channel, and the insertion flange are constructed as a single unit.

9. The flanged ring connector of claim 1, wherein the formed seam and the receiving channel extending along opposite sections of the outer perimeter portion of the mating flange.

10. The flanged ring connector of claim 1, wherein:
the formed seam extending along at least two adjacent sections of the outer perimeter portion; and
the receiving channel extending along at least two adjacent opposite sections of the outer perimeter portion of the mating flange.

11. The flanged ring connector of claim 1, wherein the outer perimeter portion of the mating flange extending between the formed seam and the receiving channel comprising a hem section extending away from the mating face in the direction that the insertion flange extends from the mating face.

12. The flanged ring connector of claim 11, wherein the outer perimeter portion of the mating flange extending between the formed seam and the receiving channel further comprising a return section extending from the hem section and toward the mating face.

13. The flanged ring connector of claim 1, wherein the flanged ring connector is formed at the end of an HVAC duct.

14. A flanged ring connector to join end-to-end adjacent ducts in an HVAC system, the flanged ring connector comprising:
a mating flange defining a mating face, the mating flange also defining a center and an outer perimeter portion extending around the mating face, a first portion of the outer perimeter portion comprising a formed seam comprising an edge section extending away from the mating face and a return section extending from the edge section toward the center;
an insertion flange extending laterally from the mating flange in the direction opposite to and away from the mating face, the insertion flange having a length sufficient to allow fixed attachment with the adjacent end portion of an HVAC duct;
a receiving channel extending along a second portion of the outer perimeter portion of the mating flange not corresponding to the formed seam, the receiving channel projecting from the mating face in a direction away from the direction that the insertion flange extends from the mating face, the receiving channel shaped and sized to receive the formed seam of the mating flange of an adjacent flanged ring connector.

15. The flanged ring connector of claim 14, wherein approximately half of the outer perimeter portion comprising the formed seam and the receiving channel extending along a second portion of the outer perimeter portion of the mating flange not corresponding to the formed seam.

16. A flanged connector used to join double wall ducts in HVAC systems, the double wall ducts having an outer duct and an inner duct of corresponding shape and disposed within the outer duct, the flanged connector comprising:
a first connector section composed of an outer insertion flange, the outer insertion flange having sufficient length to allow connection to an outer duct of a double wall duct;
an exterior mating flange extending substantially transversely outwardly from the outer insertion flange to define a first mating face and a first outer perimeter;
a second connector section composed of an inner insertion flange, the inner insertion flange having sufficient length to allow connection to an inner duct of a double wall duct;
an inner mating flange extending substantially transversely outwardly from the inner insertion flange to define a second mating face;
an inner hem that is spaced outwardly from the inner insertion flange, said inner hem extending from the outer perimeter of the inner mating flange generally in the same direction as the inner insertion flange to overlap the outer insertion flange, wherein the inner hem is connected to the outer insertion flange such that the inner mating flange and the outer mating flange are aligned, the inner hem being of such length to permit the outer insertion flange to be connected to the outer duct and having sufficient length to allow connection with the outer insertion flange;
at least one section of the first outer perimeter comprising a formed seam comprising an edge section extending away from the first mating face and a first return section extending from the edge section toward the outer insertion flange;
a receiving channel extending along at least a second section of the first outer perimeter of the exterior mating flange, the receiving channel projecting from the first mating face in a direction away from the direction that the outer insertion flange extends from the first mating face, the receiving channel shaped and sized to receive the formed seam of the exterior mating flange an adjacent flanged ring connector.

17. The flanged ring connector of claim 16, wherein the formed seam and the receiving channel extending along opposite sections of the first outer perimeter portion of the exterior mating flange.

18. The flanged ring connector of claim 16, wherein:
the formed seam extending along at least two adjacent sections of the outer perimeter portion of the exterior mating flange; and
the receiving channel extending along the other at least two adjacent sections of the outer perimeter portion of the exterior mating flange.

19. The flanged ring connector of claim 16, wherein the outer perimeter portion of the exterior mating flange extending between the formed seam and the receiving channel comprising a hem section extending away from the first mating face in the direction that the outer insertion flange extends from the first mating face.

20. The flanged ring connector of claim 16, wherein the outer perimeter portion of the exterior mating flange extending between the formed seam and the receiving channel comprising a return section extending from the hem section and in the direction towards the first mating face.
